(19) United States
(12) Patent Application Publication
(10) Pub. No.: US 2003/0060171 A1
(43) Pub. Date: Mar. 27, 2003

(54) Millimeter-wave communications link with adaptive transmitter power control

(76) Inventors: John Lovberg, San Diego, CA (US); Paul Johnson, Kihei, HI (US); Louis Slaughter, Weston, MA (US); Richard Chedester, Whately, MA (US)

Correspondence Address: Ross Patent Law Office, P.O. Box 2138, Del Mar, CA, 92014, US

(21) Appl. No.: 10/196,486

(22) Filed: Jul. 15, 2002

Related U.S. Application Data
(63) Continuation-in-part of application No. 09/847,629, filed on May 2, 2001.
(63) Continuation-in-part of application No. 09/872,542, filed on Jun. 2, 2001.

(51) Int. Cl. H04B 1/38; H04B 7/00

(52) U.S. Cl. 455/73; 455/517; 455/522

(57) ABSTRACT

An communication system equipped for automatic monitoring and adjustment of the transmitted power at both ends of a communications link to maintain the minimum required transmit power for reliable communication and to minimize the potential of interference with other communications links. A preferred embodiment of the invention is a millimeter wave system, operated level in the 71 to 76 GHz range. A received signal at one end of a communication link is used to adjust the power transmitted from the other end of the link in such a way as to maintain the received signal level within a desired range. If the received signal decreases below the desired range, the transmitted power is turned up, to maintain the link reliability and low Bit Error Rate (BER). If the received signal increases above the desired level, the transmitted power level is turned down, to reduce the potential for interference to other links. Techniques are disclosed for communicating the signal level received at one end of the communications link (or the transmitter power command) to the transmitter at the other end of the link. These techniques may be via an out-of-band link (telephone, wire, or another link operating on an entirely different frequency), or via an in-band link, the communications link itself.

The present invention relates to wireless communications links and specifically to high data rate point-to-point links. This application is a continuation-in-part application of Ser. Nos. 09/847,629 filed May 2, 2001, Ser. No. 09/872,542 filed Jun. 2, 2001, Ser. No. 09/872,621 filed Jun. 2, 2001, Ser. No. 09/882,482 filed Jun. 14, 2001, Ser. No. 09/952,591, filed Sep. 14, 2001, Ser. No. 09/965,875 filed Sep. 28, 2001, Ser. No. 10/046,348 filed Oct. 25, 2001, Ser. No. 10/001,617 filed Oct. 30, 2001, Ser. No. 09/992,251 filed Nov. 13, 2001, Ser. No. 10/000,182 filed Dec. 1, 2001 and Ser. No. 10/025,127, filed Dec. 18, 2001 all of which are incorporated herein by reference.

### BACKGROUND OF THE INVENTION

### Wireless Communication

### Point-to-Point and Point-to-Multi-Point

Wireless communication links, using portions of the electromagnetic spectrum, are well known. The communication may take the form of voice transmissions, facsimile, telemetry, or other digital data, and may employ any of a wide variety of modulation techniques. The communication may be either one-way or bi-directional. Most such wireless communication, at least in terms of data transmitted, is one-way, point-to-multi-point, which includes commercial radio and television. However, there are also many examples of bi-directional point-to-point wireless communication. Mobile telephone systems that have recently become very popular are examples of low-data-rate, bi-directional point-to-point communication. Microwave transmitters on telephone system trunk lines are another example of prior art, bi-directional point-to-point wireless communication, at much higher data rates. The prior art also includes a few examples of point-to-point laser communication at infrared and visible wavelengths.

### Weather Conditions

Weather-related attenuation limits the useful range of wireless data transmission at all wavelengths shorter than the very long radio waves. Typical ranges in a heavy rainstorm for optical links (i.e., laser communication links) are 100 meters and for microwave links, 10,000 meters. Atmospheric attenuation of electromagnetic radiation increases generally with frequency in the microwave and millimeter-wave bands. However, excitation of rotational transitions in oxygen and water vapor molecules absorbs radiation preferentially in bands near 60 and 118 GHz (oxygen) and near 23 and 183 GHz (water vapor). Rain, which attenuates through large-angle scattering, increases monotonically with frequency from 3 to nearly 200 GHz. At the higher, millimeter-wave frequencies, (i.e., 30 GHz to 300 GHz corresponding to wavelengths of 1.0 centimeter to 1.0 millimeter) where available bandwidth is highest, rain attenuation in very bad weather can limit reliable wireless link performance to distances of 1 mile or less. At microwave frequencies near and below 10 GHz, link distances to 10 miles can be achieved even in heavy rain with high reliability, but the available bandwidth is much lower.

What is needed are wireless communication systems in the millimeter wavelengths that make efficient use of the available spectrum.

### SUMMARY OF THE INVENTION

The present invention provides a communication system equipped for automatic monitoring and adjustment of the transmitted power at both ends of a communications link to maintain the minimum required transmit power for reliable communication and to minimize the potential of interference with other communications links. A preferred embodiment of the invention is a millimeter wave system, operated in the 71 to 76 GHz range. A received signal at one end of a communication link is used to adjust the power transmitted from the other end of the link in such a way as to maintain the received signal level within a desired range. If the received signal decreases below the desired range, the transmitted power is turned up, to maintain the link reliability and low Bit Error Rate (BER). If the received signal increases above the desired level, the transmitted power level is turned down, to reduce the potential for interference to other links. Techniques are disclosed for communicating the signal level received at one end of the communications link (or the transmitter power command) to the transmitter at the other end of the link. These techniques may be via an out-of-band link (telephone, wire, or another link operating on an entirely different frequency), or via an in-band link, the communications link itself. In the case of a bi-directional communications link, the command or feedback necessary between the receiver at one end and the transmitter at the other can be sent over the path of data flowing in the other direction. In the case of a large network of communications links, all monitored and controlled from a central location, the transmitted power level of each individual link can be adjusted from the central location on an ongoing basis so as to maintain the highest performance of the network as a whole. In this implementation, the signal levels received at each end of every link are sent to a central location via an in-band or out-of-band channel, where decisions on transmitter power levels are made and the commands sent out to all the transmitters in the system. Optimization of data flow may require that certain links tolerate higher interference than others, or require certain links to maintain a higher reliability or lower BER than others. As the data flow changes, the link levels may be adjusted to maintain low BER on the more highly used links, or to optimize the system in some other way.

### BRIEF DESCRIPTION OF THE DRAWINGS

FIG. 1 shows a group of point-to-point data links.

FIG. 2 depicts a situation such that interference between the links is possible if transmit powers are larger than necessary.

FIG. 3 shows a block diagram of a millimeter-wave communications link.

FIG. 4 shows a block diagram of a millimeter-wave communications transceiver.

### DETAILED DESCRIPTION OF PREFERRED EMBODIMENT

### Need for Adaptive Power Transmitter Control

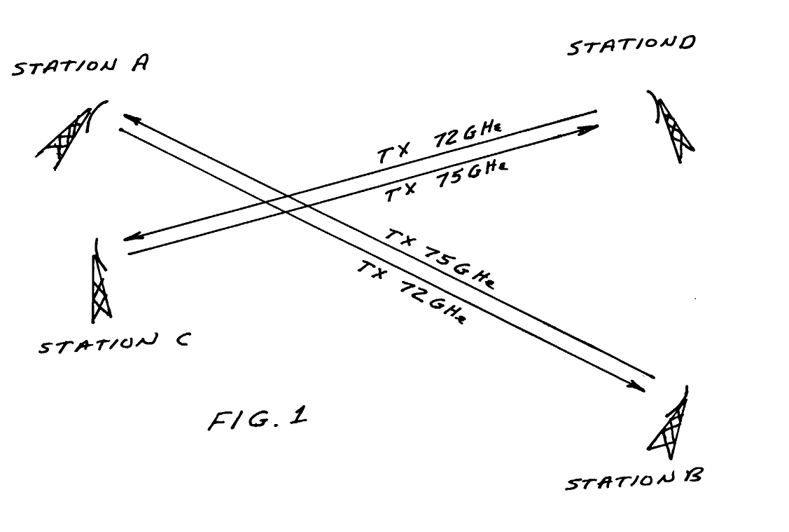

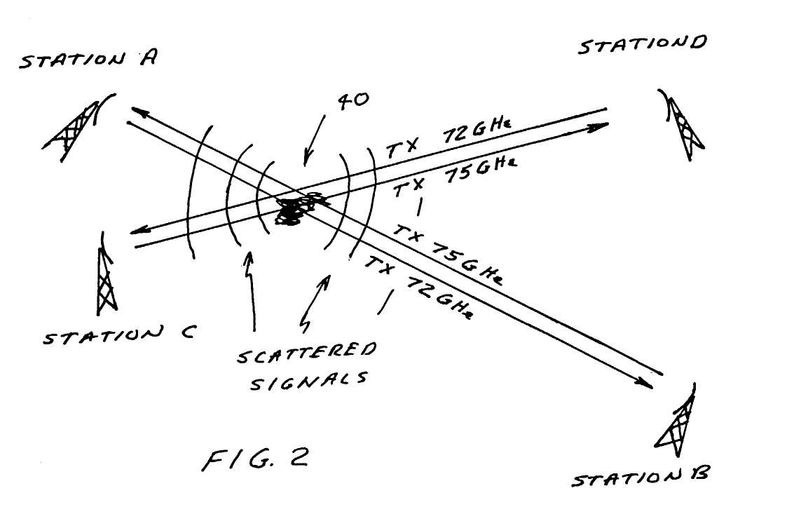

Millimeter wave point-to-point open-space communication links can be confined within less than one degree. The communication range is also limited. Therefore, the same spectral range can be used over and over again, providing almost unlimited communication channels at very high data rates. However, as these point-to-point wireless communication links proliferate, the need to prevent interference between nearby links increases, especially when these links are operating on the same or overlapping frequencies. Although millimeter-wave communication links are normally designed for narrow beams, there exists the possibility that two closely located links may interfere with each other, or that energy reflected from structures, terrain, or other objects may bounce into and along the path of another communication link, causing interference. FIG. 1 illustrates a group of point-to-point communications links that are operating in a non-interfering basis. FIG. 2 illustrates the same link but an obstruction 40, such as a building or a tree, produces some reflection of some of the transmitted signal resulting in the potential for one of the signals to interfere with one or more of the others. To minimize the potential interference between multiple links, it is desirable to operate the transmitter(s) in each link at the minimum necessary power level required to achieve reliable communications. The minimum transmitted power level for each link varies, depending on the link distance, weather conditions, terrain, atmosphere, and other factors. Some of these factors such as the weather fluctuate as a function of time. The present invention provides adaptive transmitter power control to maintain the minimum necessary transmit power under changing conditions. As weather and atmospheric conditions vary, the link path attenuation varies, causing the received signal to vary considerably. However, transmitted power is monitored and adjusted to maintain the signal level at the receiver within a desired range.

### First Preferred Embodiment

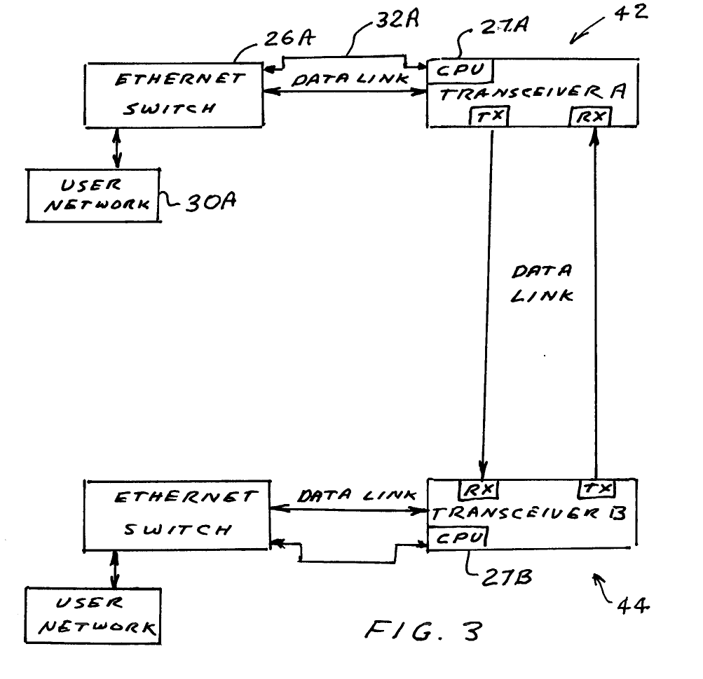

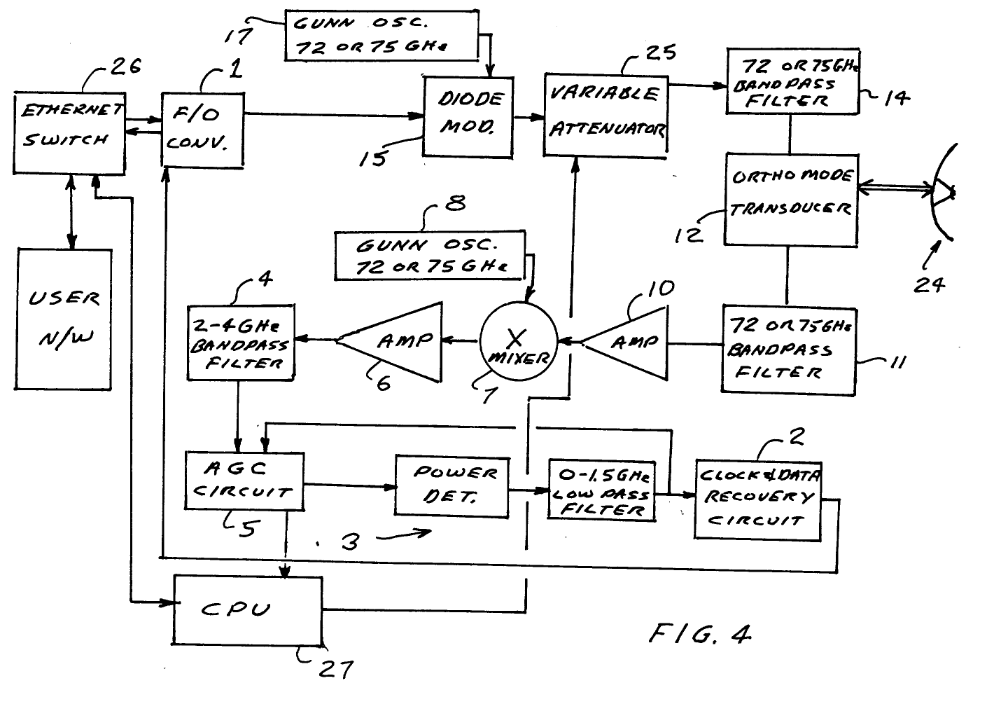

In a first preferred embodiment, a millimeter-wave (mmw) data link is configured to pass Ethernet data packets bi-directionally between the ends of the link. A block diagram of the data link is shown in FIG. 3. A block diagram of the millimeter-wave transceiver used at each end of the link is illustrated in FIG. 4. One end of the link 42 (designated as “Transceiver A”) transmits at 72 GHz and receives at 75 GHz, and the other end 44 (designated as “Transceiver B”) transmits at 75 GHz and receives at 72 GHz. Dish antennas with a diameter of 2 feet are used at each end to achieve a radiated beam width of approximately 0.34 degrees.

The received signal strength at end A is used to control the power transmitted by link end B. The received signal strength at link end B is used to control the power transmitted by link end A. The signal strength received at A is communicated to end B via the data stream flowing from A to B. The signal strength received at B is communicated to end A via the data stream flowing from B to A. The received signal strength is used to adjust the transmitted power in such a way as to keep the received signal strength within a desired range over changing conditions in the path between link ends A and B.

The received signal strength at link end A is sensed by the Central Processing Unit (CPU) 27A via the Automatic Gain Control (AGC) circuitry 5 (see FIG. 4). The CPU 27 encodes this data into message packets that are sent via an Ethernet connection as shown at 32A to an Ethernet switch 26A, which combines the CPU message packets with other Ethernet message traffic flowing from user network 30A into the radio for transmission to link end B. The CPU message flows across the data link from A to B and into an Ethernet switch 26B at link end B, which routes the CPU message (from link end A) to the CPU 27B at link end B. The CPU at link end B interprets the Ethernet message packets and extracts the signal strength received at A. The CPU 27B at link end B compares the signal strength received at A to a predetermined range, and if the received signal strength is lower than a low threshold of the predetermined range, CPU B increases the transmitted power level at link end B. If the signal strength received at link end A is determined to be above an upper threshold of the predetermined range, CPU B decreases the transmitted power level at link end B. The increase or decrease in transmitted power level at link end B is accomplished by the CPU via a variable attenuator 25 (digitally controlled) in the transmit signal path. The power level transmitted by link end A is adjusted in a similar fashion using the signal strength measured at link end B and passed to link end A over the data link. The reader should note that FIG. 4 represents both ends of the link since they are identical and the A's and B's in FIG. 4 have been dropped in the references to the components. The transceivers are described in detail below.

### Transceivers

The link hardware consists of a millimeter-wave transceiver pair, including a pair of mmw antennas 24 and a pair of Ethernet switches 26 (one for each transceiver). The mmw signal is amplitude modulated and single-sideband filtered, and includes a reduced-level carrier. The tuner receiver includes a heterodyne mixer, phase-locked intermediate frequency (IF), and IF power detector. Transceiver A (FIG. 3) transmits at 71-73 GHz, and transceiver B (FIG. 3) transmits at 74-76 GHz. Transceiver A receives at 74-76 GHz and transceiver B receives at 71-73 GHz.

The transceiver at link end A is comprised of dish antenna 24, manufactured by Milliflect Corporation, the radio electronics including CPU 27 manufactured by Diamond Systems Corporation, and an external Ethernet switch 26 manufactured by Hewlett Packard Corporation. Signals received by antenna 24 pass through the Ortho-mode Transducer 12 and a 71-73 GHz bandpass filter 11, and are amplified by low-noise amplifier 10. After being amplified the signal is mixed with the 75 GHz Local Oscillator 8 signal by mixer 7 to result in a 2-4 GHz down-converted signal. This resulting 2-4 GHz signal is amplified by amplifier 6 made by Hittite Corporation and bandpass filtered 4, before being sent to the automatic gain control (AGC) circuit 5. After passing through the AGC circuit, the signal is power detected and lowpass filtered by detector circuit 3, to result in a baseband data signal. The baseband data signal is passed to clock and data recovery circuit 2 (using an Analog Devices ADN2809 clock recovery chip), which cleans up the data waveform shape before it is converted to an optical signal by the fiber-optic interface 1, manufactured by Finisar, Incorporated.

Data incoming from the user network is acquired by the Ethernet switch 26, where it is combined with other Ethernet data, from the transceiver CPU 27 and from other user networks. The combined data stream from the Ethernet switch is sent to the Fiber-optic converter 1 and used to modulate the output of the 75 GHz Gunn oscillator 17 by diode modulator 15. The modulated signal is passed through the variable attenuator 25 and is then bandpass filtered 14 and sent to the Ortho-mode transducer 12 that routes the signal to the antenna 24.

The AGC circuit 5 senses the strength of the received signal and adjusts its level to present a fixed level to the detector circuit 3. The AGC circuit 5 also sends the sensed signal level to the CPU 27, which sends the level via the Ethernet switch 26 to the other end of the link. At the other end of the link, the Ethernet switch 26 routes the signal strength information to the CPU 27 which uses the signal strength information to command variable attenuator 25, adjusting the transmitted signal power.

### Other Embodiments

Any millimeter-wave (mmw) transceiver with a means of measuring the received signal strength and adjusting the transmitted power level may be used in the application of this invention. The received signal strength may be measured by a completely separate detection device, such as a diode detector or another receiver, rather than via the AGC circuit as illustrated in the preferred embodiment. Any means of adjusting the transmitted power level may be used in the application of this invention, including pin-diode attenuators, fixed attenuators, voltage controlled amplifiers, mechanically inserted attenuators, or other means. The commands for the transmit power level may be derived at a location remote from the transmitter, including a central location that determines the commands for many transmitters simultaneously. The antennae used in the system may be of various sizes, from 1″ to several feet in diameter. Flat panel antennas may be used in place of dish antennas. Preferred frequency ranges are 71 GHz to 76 GHz as described above and the frequency range of 92 GHz to 95 GHz. In addition, the adaptive power control implementation may be applied effectively for systems operating in the range of from about 57 GHz to about 300 GHz and may also be applied to frequency bands other than millimeter-wave, and may be used with acoustic or optical communications links as well.

While the above description contains many specifications, the reader should not construe these as a limitation on the scope of the invention, but merely as exemplifications of preferred embodiments thereof. For example, the full allocated MMW band referred to in the description of the preferred embodiment described in detail above along with state of the art modulation schemes may permit transmittal of data at rates exceeding 10 Gbits per second. Such data rates would permit links compatible with 10-Gigabit Ethernet, a standard that is expected to become practical within the next two years. The present invention is especially useful in those locations where fiber optics communication is not available and the distances between communications sites are less than about 15 miles but longer than the distances that could be reasonably served with free space laser communication devices. Ranges of about 0.1 mile to about 10 miles are ideal for the application of the present invention. However, in regions with mostly clear weather the system could provide good service to distances of 20 miles or more. Accordingly the reader is requested to determine the scope of the invention by the appended claims and their legal equivalents, and not by the examples given above.

What is claimed is:

1. A point-to-point communications system comprising:
A) a first millimeter wave transceiver system located at a first site for transmitting and receiving information to and from a second site through the atmosphere,
B) a second millimeter wave transceiver system located at said second site for transmitting and receiving to and from said first site information through the atmosphere,
C) a power control means for controlling transmit power at said first transceiver system based on information derived from received signal strength at said second transceiver system and for controlling transmit power at said second transceiver system based on information derived from received signal strength at said first transceiver system.

2. A system as in claim 1 wherein said first transceiver system is configured to transmit and receive information at frequencies greater than 57 GHz.

3. A system as in claim 1 wherein said first transceiver system is configured to transmit and receive information at frequencies greater than 90 GHz.

4. A system as in claim 1 wherein said first transceiver system is configured to transmit and receive information at frequencies between 71 and 76 GHz.

5. A system as in claim 1 wherein said first transceiver system is configured to transmit and receive information at frequencies between 81 and 86 GHz.

6. A system as in claim 1 wherein said first transceiver system is configured to transmit and receive information at frequencies between 92 and 95 GHz.

7. A system as in claim 1 wherein one of said first and second transceiver systems is configured to transmit at frequencies in the range of about 71 to 73 GHz and to receive information at frequencies in the range of about 74 to 76 GHz.

8. A system as in claim 1 wherein one of said first and second transceiver systems is configured to transmit at frequencies in the range of about 71 to 76 GHz and to receive information at frequencies in the range of about 81 to 76 GHz.

9. A system as in claim 1 wherein one of said first and second transceiver systems is configured to transmit at frequencies in the range of about 81 to 73 GHz and to receive information at frequencies in the range of about 84 to 76 GHz.

10. A system as in claim 1 wherein one of said first and second transceiver systems is configured to transmit at frequencies in the range of about 92.3 to 93.2 GHz and to receive information at frequencies in the range of about 94.1 to 95.0 GHz.

11. A system as in claim 1 wherein said power control means comprises a means for communicating received signal levels via an in-band link.

12. A system as in claim 1 wherein said power control means comprises a means for communicating received signal levels via an out-of-band link.

13. A system as in claim 12 wherein said out-of-band link is a telephone link.

14. A system as in claim 12 wherein said out-of-band link comprises a separate wireless link.

15. A system as in claim 1 wherein said system is a part of a large network and said power control means comprises systems monitored and controlled from a central location.

16. A point-to-point communications system comprising:
A) a first transceiver system located at a first site for transmitting and receiving information to and from a second site through the atmosphere,
B) a second transceiver system located at said second site for transmitting and receiving to and from said first site information through the atmosphere,
C) a power control means for controlling transmit power at said first transceiver system based on information derived from received signal strength at said second transceiver system and for controlling transmit power at said second transceiver system based on information derived from received signal strength at said first transceiver system.

17. A system as in claim 16 wherein at least one of said first and second transceiver systems is an optical or laser system.

18. A system as in claim 16 wherein one of said first and second transceiver systems is an acoustic or ultrasound system.

19. A method of point-to-point communications comprising the steps of:
A) transmitting information from a first millimeter wave transceiver system located at a first site to second millimeter wave transceiver system at a second site through the atmosphere,
B) transmitting information from the second millimeter wave transceiver system located at the second site to the first millimeter wave transceiver system at a the first site through the atmosphere,
C) using a power control means for controlling transmit power at said first transceiver system based on information derived from received signal strength at said second transceiver system and for controlling transmit power at said second transceiver system based on information derived from received signal strength at said first transceiver system.

20. A method as in claim 19 wherein said first transceiver system is configured to transmit and receive information at frequencies greater than 57 GHz.

21. A method as in claim 19 wherein said first transceiver system is configured to transmit and receive information at frequencies greater than 90 GHz.

22. A method as in claim 19 wherein said first transceiver system is configured to transmit and receive information at frequencies between 71 and 76 GHz.

23. A method as in claim 19 wherein said first transceiver system is configured to transmit and receive information at frequencies between 81 and 86 GHz.

24. A method as in claim 19 wherein said first transceiver system is configured to transmit and receive information at frequencies between 92 and 95 GHz.
